(19) United States
(12) Patent Application Publication
(10) Pub. No.: US 2016/0017182 A1
(43) Pub. Date: Jan. 21, 2016

(54) METHOD AND APPARATUS FOR RECOVERING HIGH PURITY GELATIN FROM GELATIN NET GENERATED IN GELATIN CAPSULE MANUFACTURING PROCESS

(71) Applicant: Chang Sung Softgel System Ltd, Pocheon-si (KR)

(72) Inventor: Ju-su KIM, Seoul (KR)

(21) Appl. No.: 14/674,620

(22) Filed: Mar. 31, 2015

Related U.S. Application Data
(63) Continuation of application No. PCT/KR2014/012458, filed on Dec. 17, 2014.

(30) Foreign Application Priority Data
Jul. 17, 2014 (KR) 10-2014-0090379

(51) Int. Cl. C09H 3/02; B01D 71/02; B01D 61/14

(52) U.S. Cl. CPC C09H 3/02; B01D 61/147; B01D 71/02; B01D 61/145; B01D 2321/32

(57) ABSTRACT

The present invention relates to a method and an apparatus for recovering gelatin from a gelatin net generated in a gelatin capsule manufacturing process and more particularly, to a recycle of a gelatin for use as a raw material for manufacturing a gelatin capsule by extracting a high purity gelatin through removing an additive, specifically, a coloring included in a gelatin net. To this end, in the present invention, a gelatin net is cleaned in a pre-process, the gelatin net is dissolved by a solvent, and a foreign substance is filtered by sequentially using a normal filtering scheme, a microfiltering scheme and an ultrafiltering scheme, a coloring causing material is removed in an ion separating step, and the gelatin net is concentrated and dried.

### CROSS-REFERENCE TO RELATED APPLICATION(S)

This application is a continuation application, claiming the benefit under §365(c), of an international application serial number PCT/KR2014/012458, filed on Dec. 17, 2014, which claimed the benefit of a Korean patent application filed on Jul. 17, 2014 in the Korean Intellectual Property Office and assigned Serial number 10-2014-0090379, the entire disclosure of which is hereby incorporated by reference.

### TECHNICAL FIELD

The present invention relates to a method and an apparatus for recovering gelatin from a gelatin net generated in a gelatin capsule manufacturing process, and more particularly, to a recycle of a gelatin for use as a raw material for manufacturing a gelatin capsule by extracting a high purity gelatin through removing an additive, specifically, a coloring included in a gelatin net.

### BACKGROUND

In general, soft capsules are used in various fields to disguise bad taste or scent of medicine, and is easily dissolved in the human body while having surface strength and a stable moisture resistance such that the soft capsule is used for a material for forming films of medicine, health and nutritional supplements, cosmetic products, etc. and is also used in various fields such a paint ball, which is a leisure product, etc.

The raw material for the gelatin has been typically extracted from protein of domestic animals, but currently, animal or plant gelatin capsules are manufactured by using raw materials extracted from seaweeds, etc., and various additives are mixed to manufacture the gelatin capsule.

In addition, to manufacture the gelatin capsule, after a pair of gelatin ribbons are molded on a drum, the pair of gelatin ribbons are moved to face each other between a pair of rotating dies so that the gelatin capsules are formed and filled with medicines by an inserting wedge.

Then, a gelatin net is obtained by detaching the capsule from the gelatin ribbon by using a stripper roller, etc. (Related art 1: Korean Registered Patent No. 10-0674488, related art 2: U.S. Pat. No. 6,726,841)

However, the amount of the generated gelatin net may be up to 50% or more among the gelatin ribbon used for the raw material of the soft capsule, so waste of the raw material is very severe.

Therefore, currently, the recycling of the discarded gelatin net is being attempted, however, various additives to make the gelatin ribbon into the gelatin capsule are mixed in the gelatin net so recycling the gelatin net is very difficult.

That is, the gelatin net may include not only the gelatin which is a basic element, but also plasticizers, water, preservatives, colorings, opacifying agents, flavorings, sweeteners, sugar for granting chewing properties, gastro protective agents, and, sometimes, activators.

Therefore, to extract the high purity gelatin from the gelatin net, various processes are performed to remove each additive included in the gelatin net. A typical method is a recycling method for increasing the purity of the gelatin by repetitively performing a process of inserting the gelatin net into a solvent to dilute the gelatin net and separating and concentrating the gelatin net, but extracting the high purity gelatin is very difficult even when numerous steps to remove the additives are performed.

In addition, even when the gelatin net is repetitively filtered, the coloring included in the gelatin net mostly remain so the gelatin net is difficult to recycle, and the quality of the soft gelatin capsule manufactured by using the recycled gelatin, in which the coloring is not completely removed, may be degraded.

Furthermore, excessive amount of waste water is created when the filtering process is repetitively performed, so environmental problems may occur.

Therefore, a new technology is required for extracting only the high purity gelatin among various components which are added in the gelatin net.

### SUMMARY

The present invention is provided to meet the demand described above, and to completely remove the coloring included in the gelatin net while simplifying the process for removing each additive when recovering the gelatin from the gelatin net.

To achieve the object, according the present invention, a gelatin net is cleaned in a pre-process, the gelatin net is dissolved by a solvent, and a foreign substance is filtered by sequentially performing a normal filtering scheme, a micro-filtering scheme and an ultrafiltering scheme, a coloring causing material is removed in an ion separating step, and the gelatin net is concentrated and dried.

Therefore, the gelatin net is recycled to reclaim a pure gelatin according to the present invention, such that recycling can be effectively utilized, and specifically, the gelatin having excellent purity can be obtained while simplifying the recycling process and reducing the recycling time.

In addition, waste water generated from the recycling process can be significantly reduced compared to typical recycling methods, thus it is advantageous in terms of eco-friendly policy.

In addition, the present invention can be applied when the coloring causing material does not exist and also when the coloring causing material exists by a simple manipulation.

### BRIEF DESCRIPTION OF THE DRAWINGS

FIG. 1 is a block diagram illustrating a manufacturing process of the present invention.

FIG. 2 is a block diagram illustrating an overall configuration of an apparatus according to the present invention.

FIG. 3 is a block diagram illustrating an overall configuration of an apparatus according to the present invention.

FIG. 4 and FIGS. 4A, 4B, 4C, 4D, and 4E are block diagrams and detailed views illustrating an overall configuration of an apparatus according to the present invention.

### DETAILED DESCRIPTION

A method for recovering high purity gelatin from a gelatin net generated in a gelatin capsule manufacturing process according to an exemplary embodiment of the present invention includes: an introducing step (a) of introducing the gelatin net generated in the gelatin capsule manufacturing process into a solvent; a mixing step (b) of dissolving the gelatin net while mixing the gelatin net and the solvent, in which the solvent is heated to a predetermined temperature in the introducing step; a separating step (c) of separating a solution, which is obtained during the mixing step (b) or after the mixing step (b), into a solvent layer and a non-solvent layer; a treating step (d) of removing a foreign substance included in the solvent layer obtained from the separating step (c), wherein the treating step (d) further comprises an ion separating step (e) for removing a coloring causing material among additives included in the gelatin net; and a concentrating and drying step (f) of concentrating a pure gelatin obtained from the ion separating step (e) to provide convenience of storage and usage.

In addition, an apparatus for recovering high purity gelatin from a gelatin net generated in a gelatin capsule manufacturing process includes: a cleaning tank to remove a foreign substance stained on the gelatin net; a melting tank to dissolve a gelatin cleaned in the cleaning tank and to separate the dissolved gelatin into a solvent material and a non-solvent material; a microfiltering part to make the solvent material overflow in the melting tank to discard the solvent material and to remove the foreign substance of only the non-solvent material; a primary ultrafiltering part to filter fine particles which are not filtered by the microfiltering part; a coloring material removing part to remove a coloring material included the foreign substance removed by the primary ultrafiltering part; and a secondary ultrafiltering part to filter a gelatin solution, in which the coloring material is removed by the coloring material removing part.

Hereinafter, the present invention is described in detail with reference to the accompanying drawings.

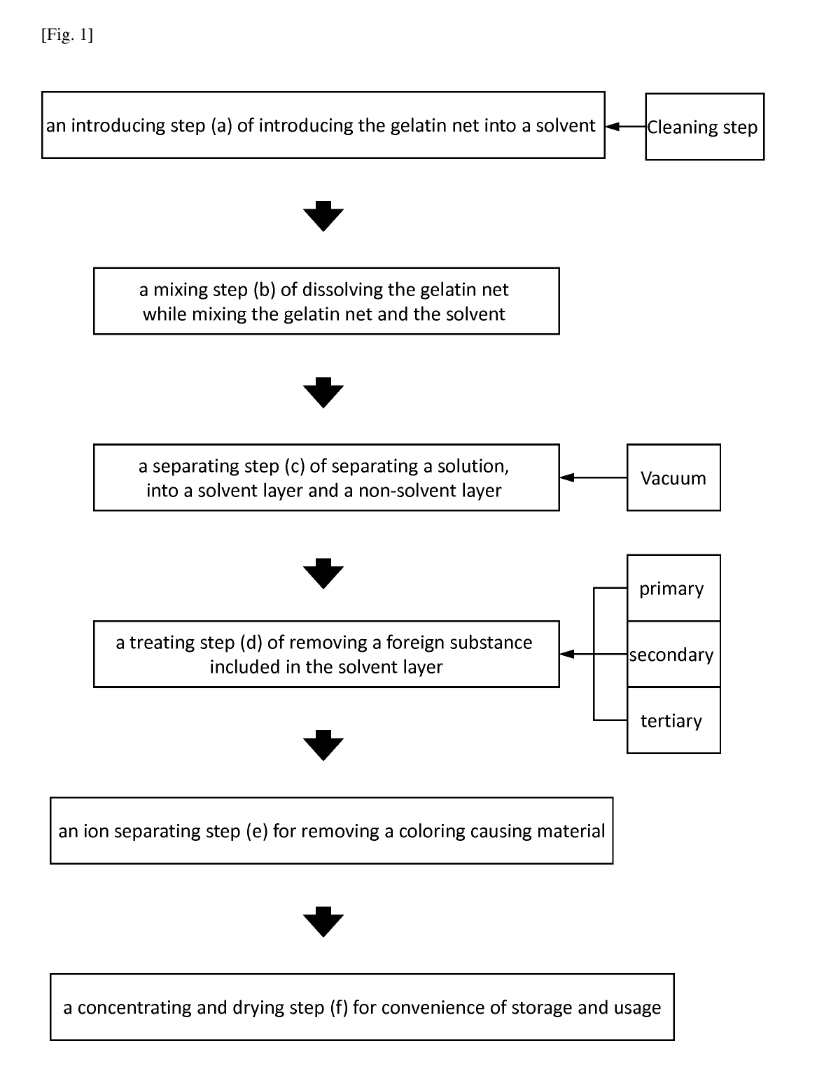

The present invention, as illustrated in FIG. 1, relates to a method for recovering gelatin from a gelatin net generated in a gelatin capsule manufacturing process, the method including: an introducing step (a) of introducing the gelatin net generated in the gelatin capsule manufacturing process into a solvent; a mixing step (b) of dissolving the gelatin net while mixing the gelatin net and the solvent, in which the solvent is heated to a predetermined temperature in the introducing step; a separating step (c) of separating a solution, which is obtained during the mixing step (b) or after the mixing step (b), into a solvent layer and a non-solvent layer; a treating step (d) of removing a foreign substance included in the solvent layer obtained from the separating step (c), wherein the treating step (d) further includes an ion separating step (e) for removing a coloring causing material among additives included in the gelatin net; and a concentrating and drying step (f) of concentrating a pure gelatin obtained from the ion separating step (e) for convenience of storage and usage.

In the present invention, a capsule is formed in a capsule manufacturing process before the introducing step (a) of introducing the gelatin net into the solvent, the gelatin net, which remains after the capsule is formed, is recovered, and the foreign substance is cleaned such that the non-solvent layer in the separating step (c) is separated more efficiently.

In this case, oil and drugs stained on the gelatin net is cleaned in a cold water (0 to 20° C.), if possible.

In this case, the reason for cleaning the gelatin net in the cold water (0 to 20° C.) is to remove only the oil and foreign substances stained on the surface of the gelatin net while preventing loss of the gelatin.

When the gelatin net is cleaned without using the cold water, the gelatin net may melt, and when the cleaning time becomes too long, the gelatin net becomes too swollen such that the gelatin net may not be readily cleaned and the product may be destroyed so product yield may drop.

In the present invention, when the time from the cleaning step to the step of introducing the gelatin net to the solvent is maintained for 40 minutes within an error range based on introducing 300 kg of the gelatin net, no loss of the gelatin net was identified.

Having completed cleaning the surface of the gelatin gel, the solvent for dissolving the gelatin net, which is cleaned, and only the gelatin included in the gelatin net are introduced through the introducing step (a).

In this case, various materials including water may be used for dissolving the cleaned gelatin net.

In the present invention, when the cleaned gelatin net is dissolved by the solvent, the gelatin net is dissolved in water of about 55° C. by taking an error range of a water temperature used for the solvent into concentration, and dissolved in an adequate concentration (5 to 15%) required for operation.

In this case, when the temperature of the water used for the solvent is higher than 55° C., from a result from an experiment performed at 65° C. in the present invention, a viscosity and strength of the gelatin decreased, and when the water temperature is lower than 55° C., from a result from an experiment performed at 45° C., the viscosity is high so a mechanical load and a filtering function decrease in the purifying process.

In addition, before introducing the gelatin net for melting, because the gelatin net sinks to a bottom of the cleaning tank, the gelatin net is introduced to the melting tank by a vacuum transferring scheme at a lower part of the cleaning tank.

Further, when an amount of the water in the melting tank is great, the concentration of the gelatin becomes lower, and when the amount of water is small, the concentration of the gelatin becomes higher, and when the concentration becomes higher, a filtering efficiency drops, when the concentration becomes lower, the filtering efficiency improves but the gelatin is required to be highly concentrated when producing a final product, and because water consumption is high, adequately maintaining the concentration of the gelatin by using an appropriate amount of water is required.

Furthermore, when the concentration of the gelatin is maintained too high, a machine becomes overly stressed, and when the concentration is maintained low, the water consumption is high so an amount of waste water is high, maintenance cost is high, and a long period of time is required for the concentration.

To this end, a content ratio of the cleaned gelatin net introduced in the introducing step (a) and the water is matched with the concentration required for operation and appropriately introduced.

Then, the oil or hydrophilic oil included in the solution dissolved in the solvent is separated to a solvent material and a non-solvent material in an overflow scheme in the melting tank so a pure gelatin solution (non-solvent material) is transferred to a treatment step by a vacuum scheme.

The water used for the solvent and the oil are separated to an upper layer by the overflow scheme through a specific gravity difference by taking economic feasibility into consideration, and the scheme corresponds to one embodiment, and the object of the present invention can be achieved by using a different and economic separating scheme.

In the present invention, the oil stained on the gelatin net is separated better when the oil is moving upward from a lower part to an upper part than when the oil is in a still state, so by continuously introducing the water used for the solvent from the lower part to the upper part, a separating yield is improved.

The gelatin solution, which is a non-solvent material in which the oil is separated, is primary filtered by using a strainer and a filtering device and transferred to a next process by a vacuum pump.

The reason for using the vacuum in the present invention is to utilize the vacuum pump by using the vacuum pump in the process for transferring the gelatin from the cleaning tank to the melting tank, and when a pressurizing pump is used for transferring the gelatin, residuals may remain, but when the gelatin is transferred by the vacuum, the residuals do not remain in the pipes and the tanks so the operation is easy and economical.

However, the use of the vacuum pump does not limit the object of the present invention, and when a separate pressurizing tank is used while using the pressurizing pump, the same object can be achieved.

After transferring the gelatin solution obtained by removing the oil included in the gelatin solution dissolved by the solvent to the treating process, the gelatin solution is primary filtered by using the strainer and the filtering device.

This is to remove the foreign substance of a fine particle included in the gelatin solution.

After the primary filtering, a secondary filtering is performed by using a microfilter to remove an additionally fine foreign substance.

A micro ceramic filter is used in the microfiltering in the present invention, so economic feasibility is achieved by repetitively using the micro filter, and the filter is also prevented from being blocked.

In this case, the drug or the foreign substance of the fine particle in a size of 0.5 μm to 0.8 μm included in the gelatin solution generated by primary filtering the gelatin solution is removed in the secondary filtering process.

In the secondary filtering, the cleaning and the filtering are automatically and simultaneously performed, and, different from the primary filtering, the secondary filtering is a tangential stress filtering scheme so a blockage of the filter is reduced and the filter can be used for a long period of time.

A tertiary filtering is performed to concentrate only the gelatin, which is a polymer and is secondary filtered as described above, and remove the drug or the hydrophilic oil having a molecular weight less than a specific molecular weight.

The tertiary filtering process has an ultrafilter (0.1 to 0.01 micron) having a finer filter hole size than the microfilter (filter hole size of 10 to 0.1 micron) in the secondary filtering process, and is generally called an ultrafiltration, which has a filter hole of 0.1 to 0.01 micron and is usually used for separating protein in life forms.

In the present invention, the ultrafiltration (UF) is used to simultaneously filter and dilute the gelatin solution obtained from a diafiltration, that is, the secondary filtering.

Therefore, by repeating the tertiary filtering process, the pure gelatin, which is the object of the present invention, is obtained.

Other filtering methods exist, however, in the case of other methods, the filter holes become smaller and blocked as time passes, so the filtering is performed by using the UF because separation in a desired molecular weight is possible and continuous filtering is possible when the ultrafilter is used.

In addition, maintaining of the temperature is determined by taking a temperature range in which a fluid flows well, a temperature range in which a quality variation of the product is the lowest, and a stability temperature of the filter into consideration.

That is, the temperature range, in which the fluid flows well, is 50° C. to 60° C., the optimal temperature for product stability is 55° C., the optimal temperature for the stability of the filter differs according to the filter, however, the operating condition is 50° C. to 70° C.

Therefore, the most appropriate operating temperature is around 55±5° C.

Even in this case, the drugs or the colorings remain on the obtained pure gelatin solution, and to remove the residual, a calumn, on which a specific ion is loaded, is used to remove the protein or the coloring apart from the gelatin included in the pure gelatin by using a characteristic of the ion.

A representative example of a material in a particle form causing the coloring is a colloid material, and the colloid particle is negatively charged in the solvent.

Therefore, the negatively charged colloid material pulls positive ions and pushes negative ions in the solvent, so negative ion materials are completely removed in the calumn in which a negative ion resin is loaded.

Even in this case, the temperature condition, as described above, is 55±5° C., and a different repulsive force may be removed by a different ion.

In addition, the removed coloring is attached to the ion and may be restored to the original form through a restoring process, and in the restoring method, a stronger ionized drug is used to remove the coloring ion component attached to the resin, then restored through cleaning.

The pure gelatin obtained from the ion separation is concentrated to a concentration convenient for reuse, then, the concentrated gelatin is dried such that the gelatin is conveniently stored or used.

In this case, the concentration condition is an adequate temperature, and a storage method stores the gelatin in a gel state by, after drying and packaging the gelatin in a liquid form, cooling the gelatin.

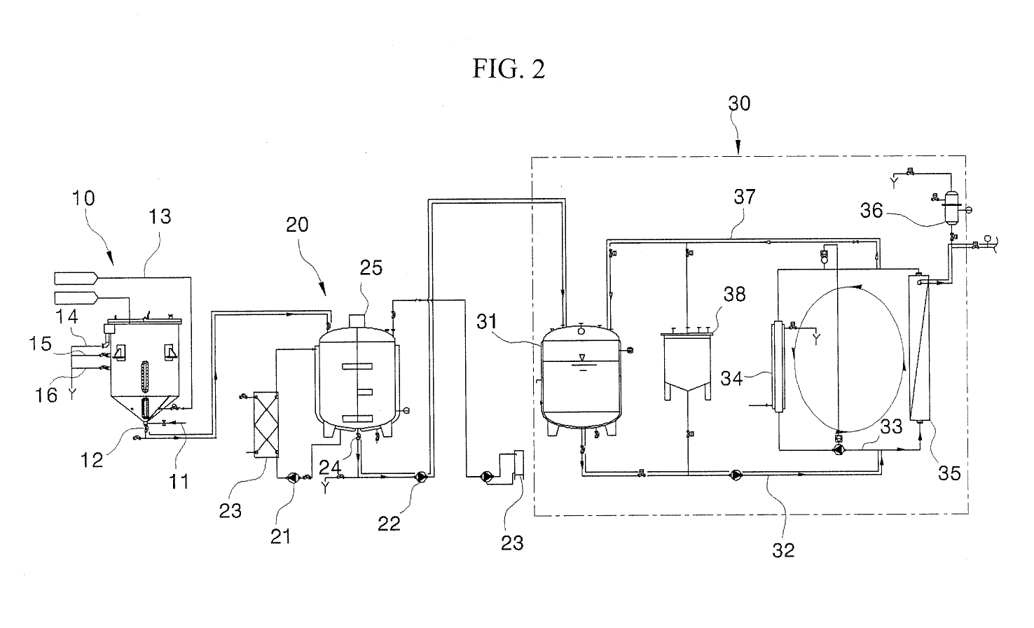

A basic configuration of an apparatus of the present invention to achieve the method, as illustrated in FIG. 2, includes: a cleaning tank to remove a foreign substance on the gelatin net; a melting tank to dissolve the gelatin cleaned in the cleaning tank and to separate the dissolved gelatin to a solvent material and a non-solvent material; a microfiltering part to make the solvent material overflow to discard the solvent material in the melting tank and to remove the foreign substance of only the non-solvent material; a primary ultrafiltering part to filter fine particles which are not filtered in the microfiltering part; a coloring material removing part to remove a coloring material included the foreign substance removed by the primary ultrafiltering part; and a secondary ultrafiltering part to filter a gelatin solution, in which the coloring material is removed in the coloring material removing part.

In this case, the coloring material removing part existing between the primary ultrafiltering part and the secondary ultrafiltering part is switched in the primary ultrafiltering part by a switching part when the coloring material does not exist in the gelatin net so that the coloring material removing part is skipped when the gelatin, in which the coloring material does not exist, is restored so that the gelatin net having the coloring material and the gelatin net without the coloring material are restored by the apparatus.

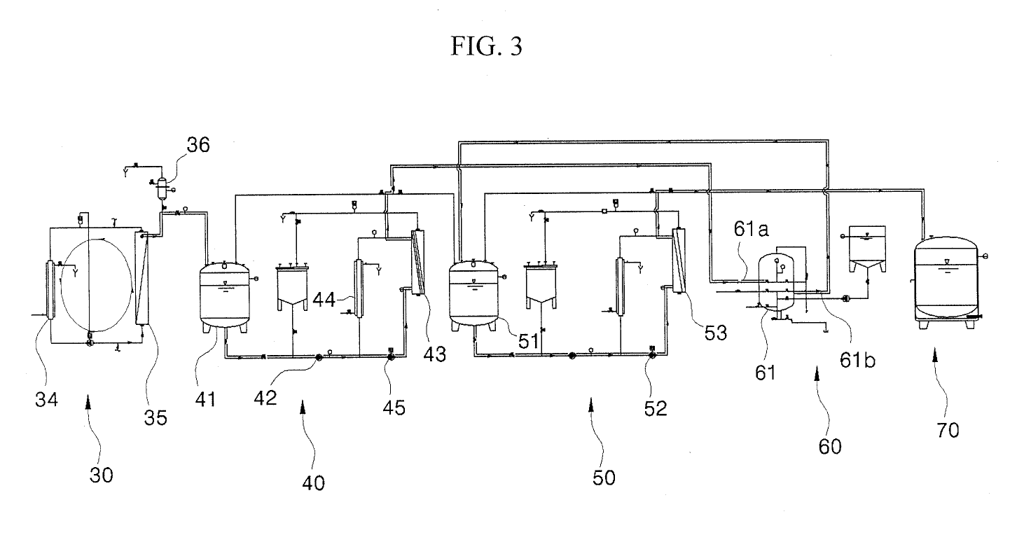

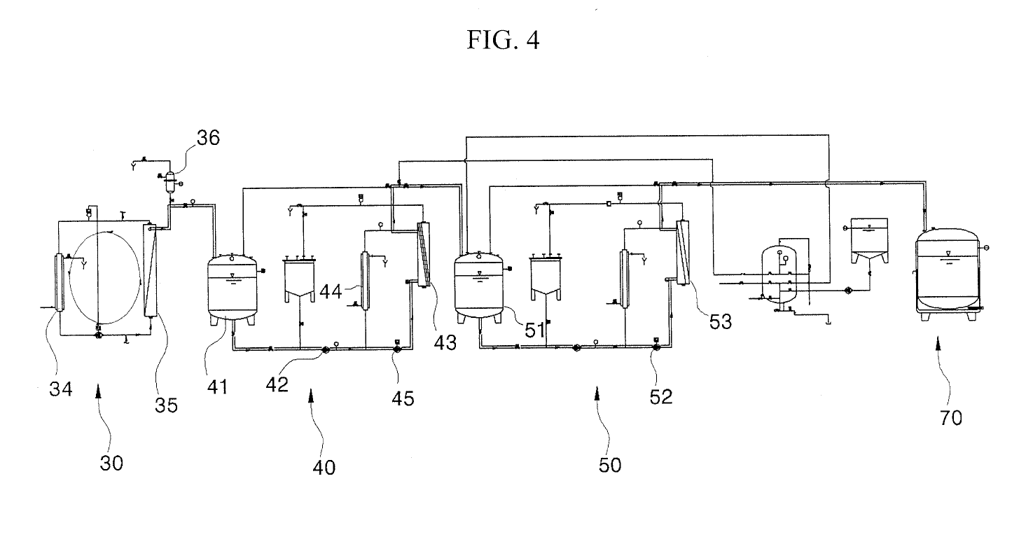

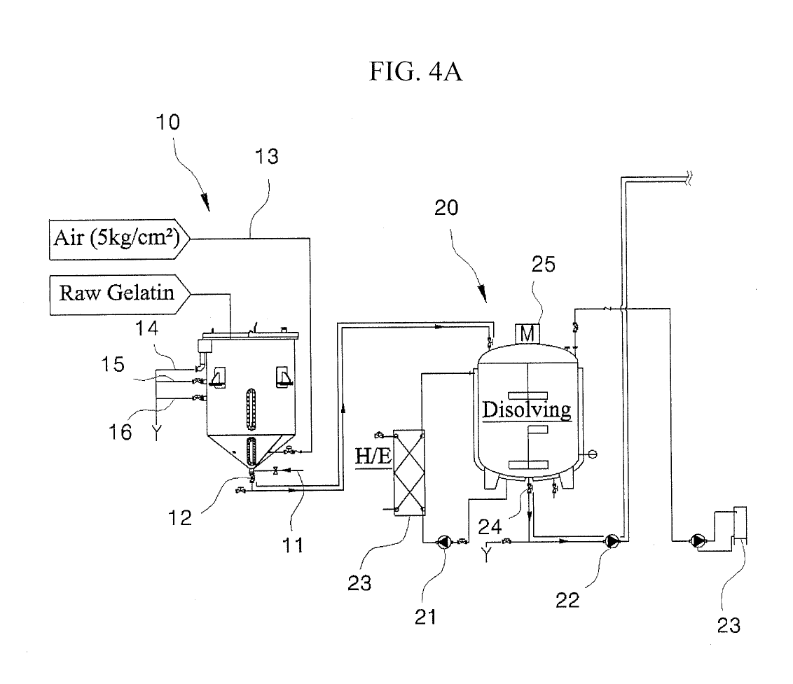

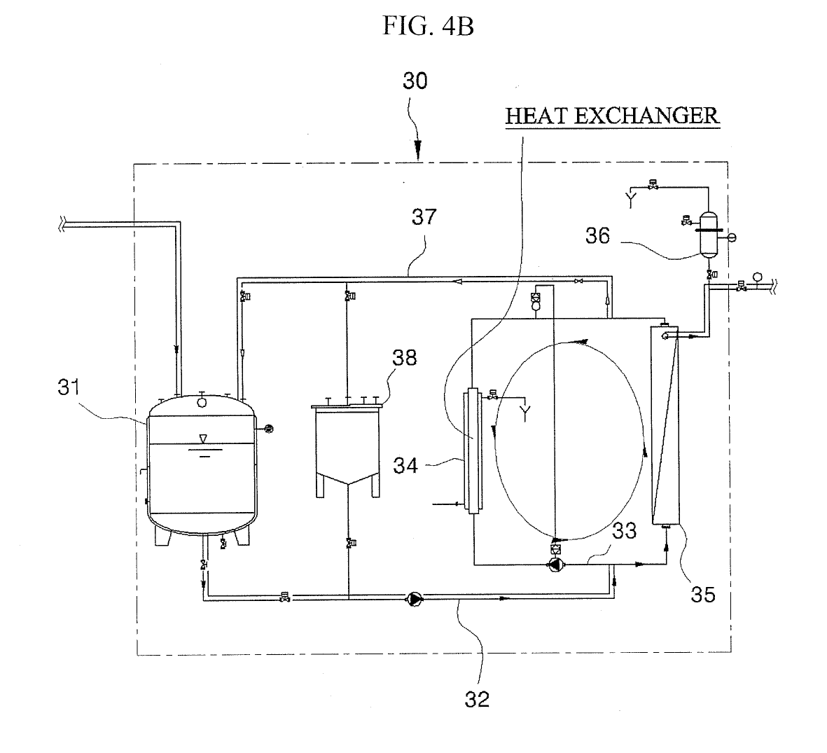

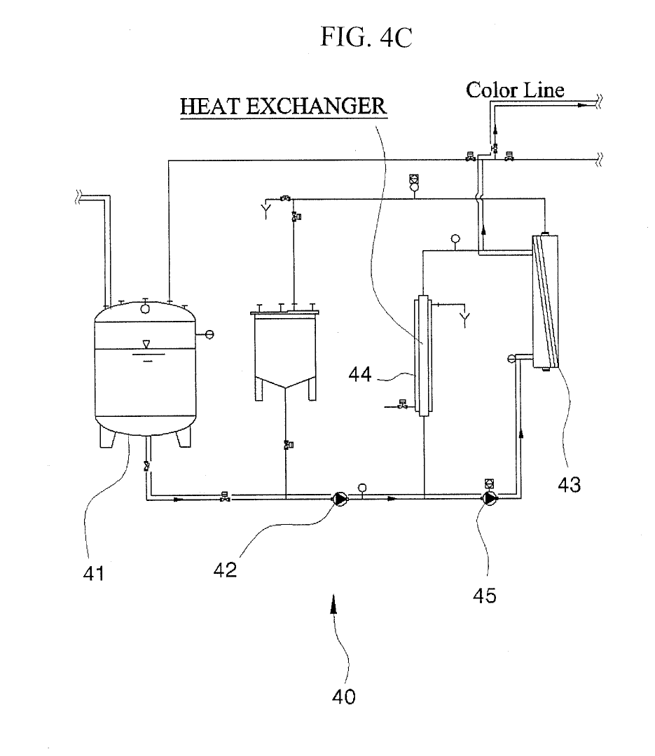

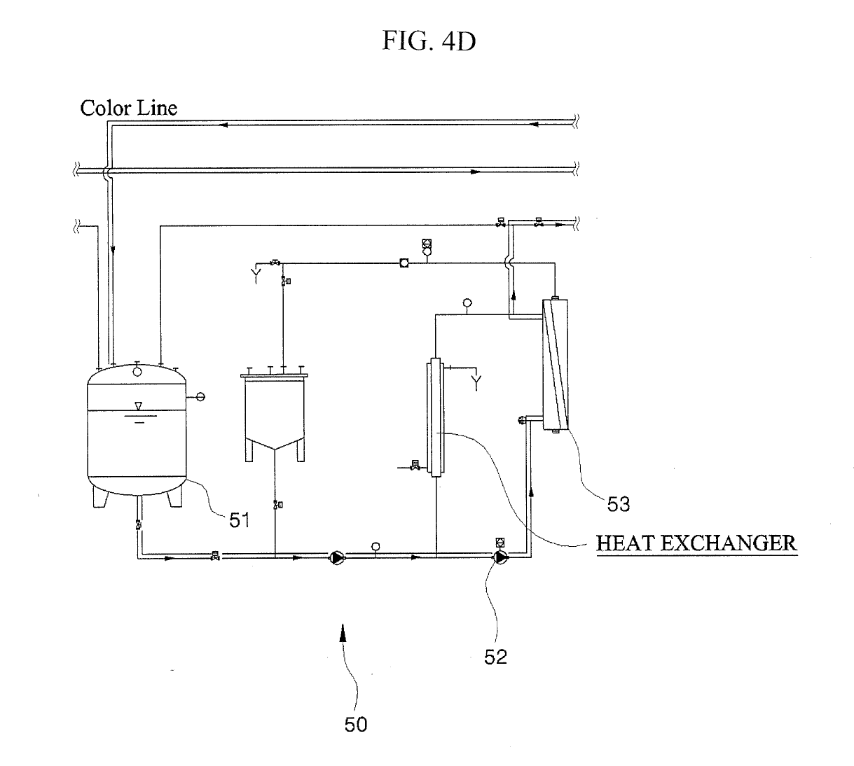

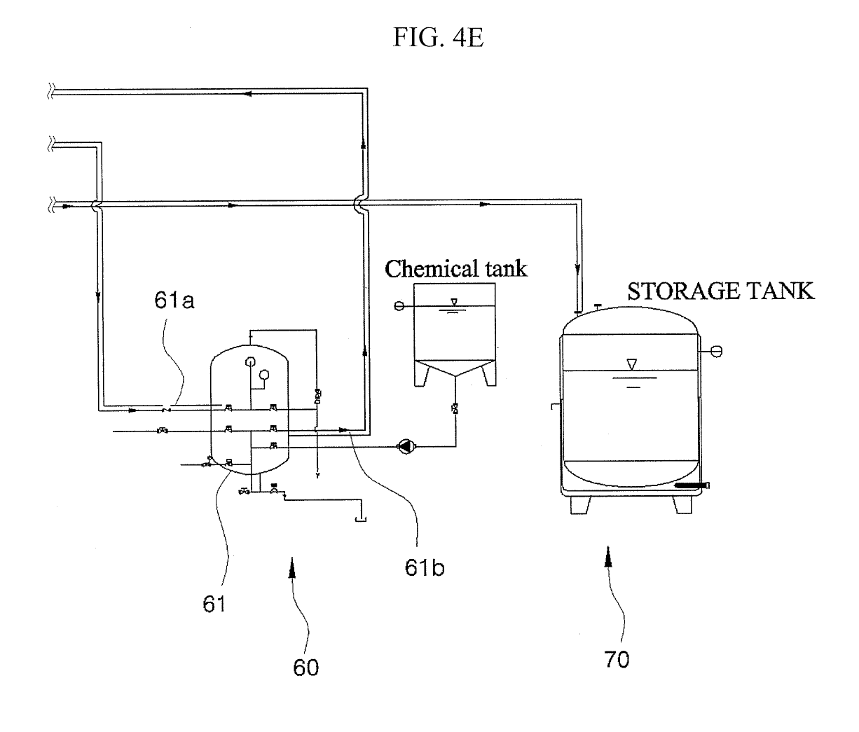

Hereinafter, a configuration of the apparatus according to an embodiment of the present invention is described in detail with reference to FIG. 3 and FIG. 4.

FIG. 4a is an enlarged view illustrating a connection state of the cleaning tank 10 and the melting tank 20 of FIG. 2. The apparatus includes a cleaning tank 10 having a supply line 11, through which the cleaning water is supplied, to use cold water for preventing the gelatin from excessive swelling or damage while removing the foreign substance or oil on the surface of the gelatin net, a drain 12 to transfer only the gelatin, in which the oil or the foreign substance included in the gelatin net is removed by overflowing, to the melting tank 20 from a bottom of the cleaning tank 10, an air supply line 13 to clean between overlapped areas of the gelatin net, an overflow line 14, from which the oil, etc. is discharged by the supplied cleaning water, first and second overflow lines 15 and 16 to make the gelatin net overflow according to an amount of the gelatin net, a vacuum pump 23 to vacuum the melting tank 20 to transfer the gelatin to the melting tank 20 from the bottom of the cleaning tank 10 through the drain 12 of the cleaning tank, a hot water circulation pump 21 to circulate heated water in the boiler 23 to maintain a constant temperature in the melting tank such that the temperature of the heated water is constantly maintained and the amount of water is constantly maintained so that the water heated to a constant temperature in the boiler 24 is used or to superbly dissolve the cleaned gelatin net transferred to the melting tank 20 by the vacuum pump 23 in the water used for the solvent, a drain 24, in which the solvent material is made to overflow and drained after the gelatin net is dissolved into the solvent material and the non-solvent material, and a first transferring pump 22, to which the gelatin solution having only the non-solvent material is transferred.

In this case, the gelatin net is mixed and separated by a mixing blade through a driving motor 25.

The generated gelatin solution is forcibly transferred to a first storage tank 31 by the first transferring pump 22 for filtering small particles included in the gelatin solution, in which the gelatin solution is transferred by using the first transferring pump 22 while only the gelatin solution, which is positioned at the bottom of the melting tank 20 and includes only non-solvent materials, is gathered at the bottom of the melting tank 20, the transferred gelatin solution is transferred to the microfiltering part 30 from the first storage tank for filtering the fine foreign substance included in the gelatin solution.

FIG. 4b is an enlarged view illustrating the microfiltering part 30 of FIG. 2 and FIG. 3, and the microfiltering part includes a first storage tank 31 to temporarily store the gelatin solution transferred by the first transferring pump 22, in which only the non-solvent material (gelatin solution) dissolved and separated in the melting tank 20 is transferred, a second transferring pump 32 to transfer the gelatin solution stored in the first storage tank 31 to the microfilter 35 to filter the foreign substance of a fine particle, a first heat exchange device 34 to filter the gelatin solution while heat exchanging the gelatin solution transferred through the second transferring pump 32 so that the gelatin solution is maintained at a constant temperature, and a first circulation pump 33 coupled to the first heat exchange device 23 to circulate the microfilter 35.

Therefore, the foreign substance of the gelatin solution is filtered in the microfilter 35 while the temperature of the gelatin solution is constantly maintained and the gelatin solution is heat exchanged in the first heat exchange device 34 by the first circulation pump 33.

In this case, when a great amount of foreign substances remain in the microfilter 35, the microfilter 35 is cleaned in the back washing tank 36 and reused, in which the gelatin is forcibly injected by air pressure, while a predetermined amount of the filtered gelatin is stored, in the back washing tank to remove the foreign substance trapped in the microfilter.

In the present invention, the lifespan of the ceramic filter is maintained for a long period of time by allowing repetitive uses by the cleaning.

In addition, when the gelatin solution is filtered in the microfilter and the pressure is instantaneously increased after a constant pressure is maintained in the microfilter part, the pressure is detected by a pressure sensor to stop the first circulation pump 23 so that the microfilter is protected from damage when the pressure increases.

In addition, when only the gelatin is filtered while the microfilter and the heat exchange device are circulated, the gelatin, which is not filtered by the repetitive filtering, is returned to the first storage tank 31 through a circulation line 37 to repeat the same process.

Further, to clean the microfilter after the gelatin recovering process, after a separate water tank 38 is secured, the water tank is cleaned by using water, and a valve is opened and closed for the cleaning.

In this case, the gelatin solution filtered by the micro-filter 35 is transferred to a primary ultrafiltering part 40 to remove an additionally fine particle (protein or coloring causing material), which is not filtered by the microfilter, so that the more fine particles are filtered.

FIG. 4c is an enlarged view illustrating the primary ultrafiltering part 40 of FIG. 3 and FIG. 4. in which the gelatin solution filtered by the micro-filter 35 is transferred to the second storage tank 41 and temporarily stored, drained at a bottom of the second storage tank 41 and transferred by the second transferring pump 42 to transfer the gelatin solution to the first ultrafilter 43, the transferred gelatin solution is circulated by the first ultrafilter 43 and the second heat exchange device 44 such that the additionally fine foreign substance is circulated and filtered by the second circulation pump 45.

The second heat exchange device 44 is for increasing filtering yield while maintaining a constant temperature to easily filter the gelatin solution when the gelatin solution is filtered by the first ultrafilter 43.

In this case, when the gelatin solution including the coloring causing material or the gelatin solution without the coloring causing material, the gelatin filtered by the first ultrafilter 43, is switched to the secondary ultrafiltering part 60 illustrated in FIG. 4e or the coloring causing material removing part 50 illustrated in FIG. 4d by the switching part and selectively transferred.

When the coloring causing material is included in the gelatin solution, the gelatin solution filtered by the first ultrafilter 43 is transferred to the coloring causing material removing part 50 through the switching part.

FIG. 4d is an enlarged view illustrating the coloring causing material removing part 50 of FIG. 3 and FIG. 4, in which the gelatin solution including the coloring causing material is switched by the switching part and introduced into the third storage tank 51 through the transfer line, the introduced gelatin solution including the coloring causing material is drained to a bottom of the third storage tank 51 and transferred to the ion exchange part 53 by the third transferring pump 52 and ion exchanged such that the negative charge included in the coloring causing material is removed by a positive charge so that the coloring material is removed.

The gelatin solution, in which the coloring material is removed, is transferred again to the secondary ultrafiltering part 60.

FIG. 4e is an enlarged view illustrating the secondary ultrafiltering part 60 of FIG. 3 and FIG. 4, in which the gelatin solution having the coloring causing material removed is introduced into a fourth storage tank 61, and the fourth storage tank includes two incoming lines 61a and 61b.

The gelatin solution is transferred through one of the incoming lines 61a from the ion exchange part, in which the coloring causing material is removed, and the gelatin solution is transferred through the other line 61b directly from the primary ultrafilter 43.

The fourth storage tank 61 including two incoming lines 61a and 61b is filled with the gelatin solution, in which almost all of the foreign substance is removed, and the gelatin solution is drained to the bottom of the fourth storage tank 61, in which the gelatin solution is temporarily stored, and transferred by the fourth transferring pump such that the gelatin solution is circulated by the second ultrafilter and a third heat exchange device while being filtered by the fourth circulation pump.

The gelatin solution, which is filtered by the second ultrafilter while being circulated by the fourth circulation pump and in which the foreign substance is completely removed, is obtained.

The gelatin solution, in which the foreign substance is completely removed, is discharged through a discharging line and is processed by using a separate concentration device or a dryer 70 and stored.

In the present invention, cool water supplied to the heat exchange device is to cool the heat generated in the process of filtering the gelatin, and the cool water is simultaneously supplied by using one supply pipe.

What is claimed is:

1. A method for recovering high purity gelatin from a gelatin net generated in a gelatin capsule manufacturing process, the method comprising:
an introducing step (a) of introducing the gelatin net generated in the gelatin capsule manufacturing process into a solvent;
a mixing step (b) of dissolving the gelatin net while mixing the gelatin net and the solvent, in which the solvent is heated to a predetermined temperature in the introducing step;
a separating step (c) of separating a solution, which is obtained during the mixing step (b) or after the mixing step (b), into a solvent layer and a non-solvent layer;
a treating step (d) of removing a foreign substance included in the solvent layer obtained from the separating step (c), wherein the treating step (d) further comprises an ion separating step (e) for removing a coloring causing material among additives included in the gelatin net; and
a concentrating and drying step (f) of concentrating a pure gelatin obtained from the ion separating step (e) to provide convenience of storage and usage.

2. The method according to claim 1, wherein heated water is used for the solvent used in the mixing step.

3. The method according to claim 1, wherein the treating step comprises primary filtering, secondary microfiltering and tertiary ultrafiltering.

4. The method according to claim 1, wherein a calumn, in which an ion is loaded, is used for removing the coloring causing material in the treating step.

5. The method according to claim 1, wherein water of a normal temperature of 0° C. to 20° C. is used for cleaning to remove the foreign substance on a surface of the gelatin net before the introducing step.

6. The method according to claim 1, wherein a temperature of the water heated in the mixing step is 55±5° C.

7. An apparatus for recovering high purity gelatin from a gelatin net generated in a gelatin capsule manufacturing process, the apparatus comprising:
a cleaning tank to remove a foreign substance stained on the gelatin net;
a melting tank to dissolve a gelatin cleaned in the cleaning tank and to separate the dissolved gelatin into a solvent material and a non-solvent material;
a microfiltering part to make the solvent material overflow in the melting tank to discard the solvent material and to remove the foreign substance of only the non-solvent material;
a primary ultrafiltering part to filter fine particles which are not filtered by the microfiltering part;
a coloring material removing part to remove a coloring material included the foreign substance removed by the primary ultrafiltering part; and
a secondary ultrafiltering part to filter a gelatin solution, in which the coloring material is removed by the coloring material removing part.

8. The apparatus according to claim 7, wherein a switching part is provided at a rear end of the primary ultrafiltering part in such a manner that the coloring material removing part provided between the primary and secondary ultrafiltering parts is selectively used in cases when the coloring material exists in the gelatin net and when the coloring material does not exist in the gelatin net.

9. The apparatus according to claim 7, wherein the cleaning tank comprises a supply line to supply cleaning water, a drain to transfer only the gelatin to the melting tank, a vacuum pump to pump the melting tank into a vacuum state so that the gelatin is transferred to the melting tank, and a hot water circulating pump to circulate heated water to maintain a constant temperature in the melting tank such that the heated water maintains a constant temperature and maintains a constant amount of water thereby reducing amount of water used or excellently dissolving the cleaned gelatin net when the water heated to a predetermined temperature in a boiler is used for the solvent to dissolve the cleaned gelatin net transferred to the melting tank by the vacuum pump, wherein the gelatin net is dissolved into a solvent material and a non-solvent material and the solvent material is made to overflow so that a gelatin solution comprising only the non-solvent material is generated.

10. The apparatus according to claim 9, further comprising:
a first transferring pump (22) to transfer the gelatin solution to a first storage tank (31) to filter small particles included in the generated gelatin solution,
wherein the microfiltering part to filter a fine foreign substance included in the gelatin solution transferred to the first transferring pump comprises:
a first storage tank to temporarily store the gelatin solution transferred by the first transferring pump;
a second transferring pump to transfer the gelatin solution stored in the first storage tank to a microfilter to filter the fine foreign substance included in the gelatin solution;
a first heat exchanger to filter the gelatin solution while heat exchanging the gelatin solution, which is transferred through the second transferring pump, so that the gelatin solution maintains a constant temperature;
a first circulating pump to circulate the microfilter coupled to the first heat exchanger; and
a back washing tank to remove the foreign substance on the microfilter so that the micro-filter is cleaned and recycled.

11. The apparatus according to claim 10, wherein a ceramic filter is used for the microfilter.

12. The apparatus according to claim 10, wherein the gelatin solution filtered by the microfilter is transferred to a second storage tank and temporarily stored, drained from a lower end of the second storage tank and transferred by the second transferring pump so that the gelatin solution is transferred to the first ultrafilter, and the apparatus further comprises a second circulating pump to circulate the transferred gelatin solution to the first ultrafilter and the second heat exchange pump to filter a more fine foreign substance by forcibly circulating the more fine foreign substance.

13. The apparatus according to claim 10, wherein, when the gelatin solution including the coloring causing material or the gelatin solution without the coloring causing material is filtered, the gelatin solution filtered by the primary ultrafiltering part is switched to the secondary ultrafiltering part or the coloring causing material removing part by the switching part such that the gelatin solution, in which the foreign substance or the coloring is removed, is selectively transferred and selectively introduced into two introducing lines (61a and 61b) of a fourth storage tank of the secondary ultrafiltering part.

14. The apparatus according to claim 8, wherein the cleaning tank comprises a supply line to supply cleaning water, a drain to transfer only the gelatin to the melting tank, a vacuum pump to pump the melting tank into a vacuum state so that the gelatin is transferred to the melting tank, and a hot water circulating pump to circulate heated water to maintain a constant temperature in the melting tank such that the heated water maintains a constant temperature and maintains a constant amount of water thereby reducing amount of water used or excellently dissolving the cleaned gelatin net when the water heated to a predetermined temperature in a boiler is used for the solvent to dissolve the cleaned gelatin net transferred to the melting tank by the vacuum pump, wherein the gelatin net is dissolved into a solvent material and a non-solvent material and the solvent material is made to overflow so that a gelatin solution comprising only the non-solvent material is generated.

15. The method according to claim 3, wherein a calumn, in which an ion is loaded, is used for removing the coloring causing material in the treating step.

16. The method according to claim 2, wherein a temperature of the water heated in the mixing step is 55±5° C.
